(19) United States
(12) Patent Application Publication
(10) Pub. No.: US 2025/0362031 A1
(43) Pub. Date: Nov. 27, 2025

(54) ASSEMBLY FOR A STOWABLE AND DEPLOYABLE COOKING DEVICE

(71) Applicant: John RYAN, Montgomery, TX (US)

(72) Inventor: John RYAN, Montgomery, TX (US)

(21) Appl. No.: 18/672,330

(22) Filed: May 23, 2024

(51) Int. Cl. F24C 15/08; B60N 3/16

(52) U.S. Cl. CPC F24C 15/08; B60N 3/16

(57) ABSTRACT

Disclosed is an assembly for a cooking device that can be stowed in and deployed from a compartment of a recreational vehicle. The cooking device has a body, a lid, and fuel source box. The body of the cooking device is attached to a pair of sliding rails contained in the compartment and has a height less than the height of the compartment. A lid and fuel source box are removably attached to the body of the cooking device via a quick-connect and disconnect mechanism. When the lid is attached to the body of the cooking device, the cooking device and fuel source box have a height greater than the height of the compartment, ensuring that the cooking device is cooled and disassembled prior to stowing the body of the cooking device in the compartment.

### CROSS-REFERENCE TO RELATED APPLICATIONS

Not applicable.

### BACKGROUND OF THE INVENTION

The present invention relates to a cooking device assembly. More particularly, the present invention relates to a cooking device assembly that can be stowed in and deployed from a compartment of a recreational vehicle or trailer, wherein the cooking device has a removable lid and fuel source box.

Recreational vehicles provide a convenient means of transportation and living quarters to travelers exploring various destinations. One of the benefits of using a recreational vehicle to travel is the ability to cook and enjoy meals in scenic locations, such as a campground. However, the typical cooking device assembly for use with recreational vehicles requires external storage or cumbersome setups, leading to space constraints and inconvenience for the recreational vehicle's user.

As a result, several types of cooking device assemblies that can be stowed in and deployed from a recreational vehicle or trailer have been developed in the past. Unfortunately, these assemblies still suffer from issues with stowing the cooking device due to the cooking device's temperature after use and the lack of room in the recreational vehicle's compartment for storage. Furthermore, there is a significant risk of damage or injury when the hot cooking device is stored in the recreational vehicle's compartment with the cooking device's fuel source.

In an effort to address the issues with stowing the cooking device in the compartment of the recreational vehicle, many of these assemblies use a relatively small cooking device that does not include the use of a lid or fuel source box. However,, the use of a lid and fuel source box provides additional benefits to the cooking device's efficiency and the user's safety.

The use of a lid over a cooking device's heated surface increases the cooking device's ability to retain heat, resulting in an increase in the cooking device's efficiency. The increase in the cooking device's efficiency then leads to faster cooking times, especially when the food requires a long cooking duration. The use of a lid also allows the cooking device to retain more moisture and more flavors of the food, resulting in better-tasting food. Additionally, the lid of a cooking device protects the cooking device's user from accidentally making direct contact with the cooking device's heated surface or from flare-ups from the cooking device.

The use of a fuel source box ensures that the cooking device's source of fuel is protected from external hazards. Protecting the fuel source of the cooking device helps preserve the quality and integrity of the fuel and mitigates damage to the cooking device's connection to the fuel source to increase the life of the cooking device and ensure that the cooking device is efficiently receiving fuel. Additionally, the use of a fuel source box reduces the chance of damage or injury caused by the exposure of the fuel to a heat source.

Various patents have issued in the past related to cooking devices, including those intended for use with recreational vehicles. For example. U.S. Pat. No. 3,692,351, issued on Sep. 19, 1972 to Christopher et al., describes a cooking apparatus which is slidably received in a compartment of a recreational vehicle. The cooking apparatus has a cover which when folded upwardly serves as a splatter panel during cooking. When folded downwardly, the cover rests over the cooking surface so that the cooking apparatus can be stowed in the compartment of the recreational vehicle. As can be appreciated, the cooking apparatus of this patent can be easily stowed when hot, resulting in the significant risk of fire.

U.S. Pat. No. 10,710,491, which issued to Groover et al. on Jul. 14, 2020, teaches another cooking apparatus for recreational vehicles. In this patent, an entire outdoor kitchen assembly is slidably received in a compartment of the recreational vehicle. Once the outdoor kitchen slides out from the compartment, it can be unfolded to serve as an outdoor kitchen. Again, this apparatus may be easily and dangerously stored when the cooking surface is still hot.

U.S. Patent Application Publication No. 2014/0366861, which published on Dec. 18, 2014 to Johnson, teaches another type of cooking apparatus which is stowable in a compartment of a recreational vehicle. In particular, a teppanyaki grill is slidably received in the compartment on a pair of slide rails, while table surfaces can slide outwardly in a direction perpendicular to the slide rails from a stowed position within the grill portion of the apparatus.

U.S. Pat. No. 10,578,313, which issued on Mar. 3, 2020 to Reischmann, proposes a unique solution for stowing cooking devices in a compartment with limited height. In particular, the patent describes a cover for a cooking surface that has a collapsible portion such that the effective height of the lid and cooking apparatus can be reduced for storage. The collapsible portion is composed of a thermally insulating material that is also collapsible. As such, this surface would necessarily cool faster than the body of the cooking apparatus, making storage while the device is hot still possible.

Various other patents and published patent applications relate to cooking apparatuses and grills, such as those which are integrated or attached to the tailgate of a truck (see, for example, US2009/0174212, US2022/0082264 and US2012/0080467.

Therefore, what is needed is an assembly for an easily stowable and deployable cooking device with a lid and fuel source box that requires the user to allow the cooking device to fully cool prior to stowing the body of the cooking device in the compartment of a recreational vehicle.

It is another object of the present invention to provide a cooking device wherein the lid is quickly detachable.

It is another object of the present invention to provide a cooking device wherein the fuel source box is quickly detachable.

It is another object of the present invention to provide an assembly which enables pellet-style grills to be used and stored in recreational vehicles.

It is yet another object of the present invention to provide a cooking device wherein hot fuel sources can be easily disposed of.

It is yet another object of the present invention to provide a cooking device which can be retrofit onto the existing sliding mechanisms of recreational vehicles.

These and other objects and advantages of the present invention will become apparent from a reading of the attached specification and appended claims.

### SUMMARY OF THE INVENTION

The main purpose of the present invention is to provide an assembly for a cooking device that can easily be stowed in and deployed from a compartment in a recreational vehicle or trailer, wherein the cooking device's user must allow the cooking device to cool and remove the cooking device's lid and fuel source box prior to stowing the body of the cooking device.

The present invention is a recreational vehicle cooking assembly including a recreational vehicle compartment having an opening with a height. A cooking device is slidably received in the recreational vehicle compartment, the cooking device having a body with a height, wherein the height of the body is less than the height of the opening of the recreational vehicle compartment. A cooking device lid is removably attached to the cooking device body. The cooking device lid and body having a combined height greater than the height of the opening of the recreational vehicle compartment.

In an embodiment. The cooking assembly includes a fuel source box removably attached to the cooking device body, the fuel source box having a height greater than the height of the opening of the recreational vehicle compartment. The cooking device may be a pellet grill, wherein the fuel source box includes: a chamber for storage of fuel pellets; a horizontal extension received in the cooking device body; and an auger extending through the horizontal extension. The cooking device may also be an offset smoker, wherein the fuel source box is a fire box.

In an embodiment, the cooking device lid is removably attached to the cooking device body with a quick-connect mechanism. The quick-connect mechanism may have a male portion slidably received in a female portion. The quick-connect mechanism may also be a pin received through aligned passageways formed on both the cooking device lid and the cooking device body.

In an embodiment, the fuel source box is removably attached to the cooking device body with a quick-connect mechanism. The quick-connect mechanism may be a key hole and a corresponding bolt head sized to fit within the key hole.

The present invention is also a cooking device including a cooking device body, a cooking device lid removably attached to the cooking device body with a first quick connect mechanism, and a fuel source box removably attached to the cooking device body with a second quick connect mechanism.

In an embodiment, the first and second quick connect mechanisms each include a male portion slidably received in a female portion. The male portion and female portion may collectively form a hinge wherein the male portion slides horizontally so as be received by the female portion. The male portion may also be a pin, wherein the female portion is a set of aligned passageways.

In an embodiment, the male portion includes a bolt having a bolt head, and the female portion includes a key hole slot, the bolt head being received in the key hole slot.

In an embodiment, the fuel source box includes: a chamber for storage of fuel pellets, a horizontal extension received in the cooking device body, and an auger extending through the horizontal extension.

The present invention is also a recreational vehicle cooking assembly including a recreational vehicle compartment having an opening with a height, and a cooking device slidably received in the recreational vehicle compartment. The cooking device includes: a body with a height, wherein the height of the body is less than the height of the opening of the recreational vehicle compartment; a lid removably attached to the cooking device body with a first quick-connect mechanism, the lid and body having a combined height greater than the height of the opening of the recreational vehicle compartment; and a fuel source box removably attached to the cooking device body with a second quick connect mechanism.

In an embodiment, the cooking device is a pellet grill, and the fuel source box is adapted to store fuel pellets. The fuel source box may include a chamber for storage of the fuel pellets, a horizontal extension received in the cooking device body, and an auger extending through the horizontal extension.

In an embodiment, the first and second quick connect mechanisms each include a male portion slidably received in a female portion.

In an embodiment, the male portion and female portion of the first quick connect mechanism collectively form a hinge, wherein the male portion slides horizontally so as be received by the female portion.

The main effect and advantage of the present invention is that the cooking device can be easily stowed in and deployed from a compartment of a recreational vehicle or trailer while enjoying the benefits of a lid and fuel source box and avoiding the issues and dangers associated with stowing a hot cooking device in a compartment.

This foregoing Section is intended to describe, with particularity, the preferred embodiments of the present invention. It is understood that modifications to this preferred embodiment can be made within the scope of the present claims. As such, this Section should not to be construed, in any way, as limiting of the broad scope of the present invention. The present invention should only be limited by the following claims and their legal equivalents.

### BRIEF DESCRIPTION OF DRAWINGS

FIG. 1 is a perspective view of the preferred embodiment of the present invention, wherein the relative heights of the cooking device and recreational vehicle compartment are shown.

FIG. 2 is a perspective view of the preferred embodiment of the present invention when the cooking device is disassembled.

FIG. 3 is a top view of the quick-connect and disconnect mechanism that removably attaches the lid to the body of the cooking device.

FIG. 3A is a top view of an embodiment of the quick-connect and disconnect mechanism that removably attaches the fuel source box to the body of the cooking device.

FIG. 4 is a top view of an embodiment of the quick-connect and disconnect mechanism that removably attaches the fuel source box to the body of the cooking device.

FIG. 5 is an embodiment of the present invention, wherein the cooking device is a pellet smoker.

### DETAILED DESCRIPTION OF THE INVENTION

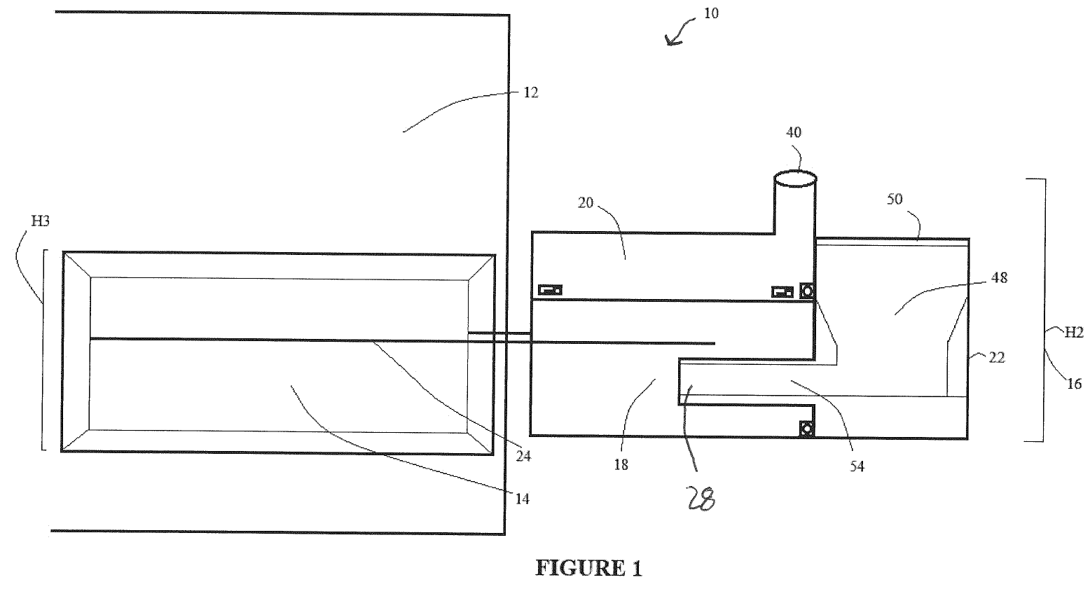

In FIGS. 1-4, the preferred embodiment of the assembly for a stowable and deployable cooking device is shown. The assembly 10 includes a recreational vehicle 12 having a compartment 14, and a cooking device 16 having a body 18, a lid 20, and a fuel source box 22.

As show in FIG. 1, the compartment 14 of the recreational vehicle 12 has a height H1 that is less than the height H2 of the assembled cooking device 16. As a result, the compartment 14 is unable to stow the entirety of the cooking device 16. Therefore, after the cooking device 16 is used, it must be allowed to cool and be disassembled prior to being stowed in the compartment 14.

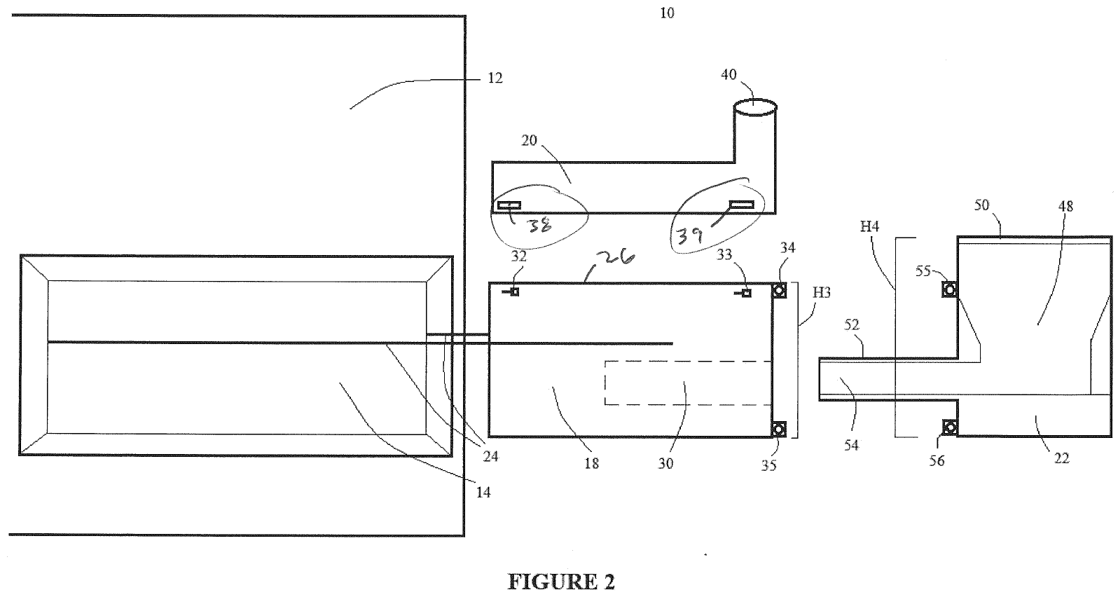

The compartment 14 contains a pair of slide rails 24, that are connected to the body 18 of the cooking device 16. A table surface (not shown) may also be provided and attached to the slide rails 24. As shown in FIG. 2, the body 18 has a height H3 that is less than the height H1 of the compartment 14, so as to allow the body 18 of the cooking device 16 to be stowed in and deployed from the compartment 14 via the pair of sliding rails 24. Due to the body 18 having a height H3 less than the height H1 of the compartment 14 and the connection of the body 18 to the slide rails 24, the body 18 can be safely stowed and transported in the compartment 14 of the recreational vehicle 12. It is understood that the present invention could be used with any compartment that has height greater than the height H3 of the body 18, such as the compartment of a trailer.

The body 18 includes a heating surface 26, a heating element 28, and a cavity 30. The heating surface 26 receives heat from the heating element 28, to allow the user of the cooking device 16 to cook on the heating surface 26. On one side of the body 18 there are a pair of quick-connect and disconnect members 32 and 33, and on another side of the body 18 there are preferably four quick-connect and disconnect members (34 and 35 being visible in FIG. 2).

The lid 20 includes a pair of quick-connect and disconnect receiving members 38 and 39 on one side thereof and a chimney 40 to provide air flow from the cooking device 16. The lid 20 is removably attached to the body 18 via the quick-connect and disconnect mechanism. In FIG. 2, the quick-connect and disconnect members 32 and 33 are shown as having male portions, whereas the quick-connect and disconnect members 38 and 39 are shown as female portions receiving the male portions of the quick-connect and disconnect members 32 and 33.

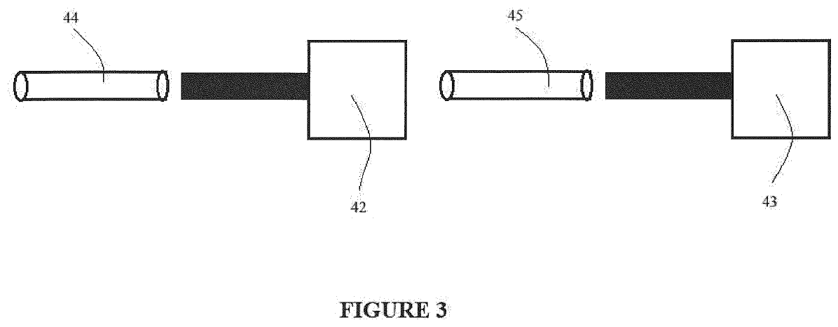

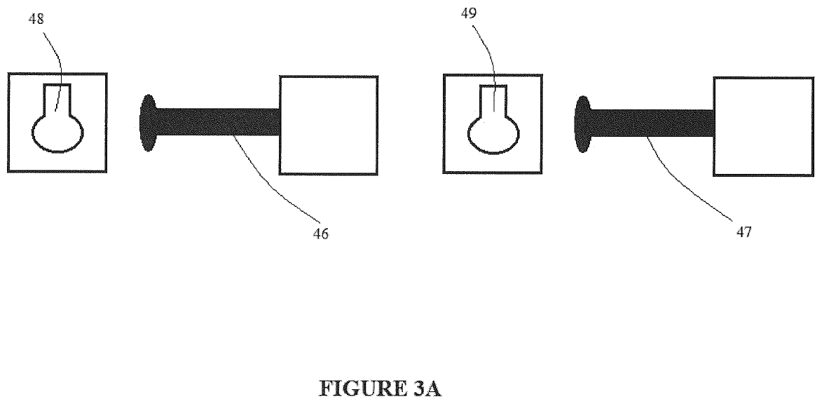

In FIG. 3, the quick-connect disconnect mechanism that removably attaches the lid 20 to the body 18 is shown. On the body 18, the quick-connect and disconnect members 32 and 33 are in the form of male weld hinges 42 and 43. The quick-connect and disconnect members 38 and 39 on the lid 20 are in the form of female weld hinges 44 and 45. The lid 20 is removably attached to the body 18 through the horizontal entry of the male weld hinges 44 and 45 of the body 18 into the female weld hinges 42 and 43 of the lid 20. Preferably, the quick-connect and disconnect members of the body/lid connection are in the form of hinges.

FIG. 3A illustrates an embodiment of quick-connect and disconnect members 34 and 35 be in the form of bolt heads 46 and 47. In an example, the quick-connect and disconnect members 34 and 35 on the body may be in the form of key hole slots 48 and 49. The fuel source box 22 is then removably attached to the body 18, through the entry of the bolt heads 46 and 47 on the fuel source box 22 into the key hole slots 48 and 49 on the body 18. The use of bolt heads with key hole slots allow the user of the cooking device 16 to quickly and easily connect or disconnect the fuel source box 22 without the use of any tools. Other manners of connecting the components of the assembly are discussed below.

After the lid 20 is removably attached to the body 18, the lid 20 is capable of covering the heating surface 26. The covering of the heated surface 26 allows the cooking device 16 to retain more heat, more moisture, and more flavor, resulting in an increase in the efficiency of the cooking device 16 and better-tasting food. Additionally, when the heating surface 26 is covered the user of the cooking device 16 is prevented from making direct contact with the heating surface 26 to avoid injury.

When the lid 20 is removably attached to the body 18, the cooking device 16 has a height H2 that is greater than the height H1 of the compartment 14. As such, the lid 20 must be removed prior to stowing the body 16 in the compartment 14 of the recreational vehicle 12. However, in order to remove the lid 20, the user must wait for the cooking device to cool. Therefore, the present invention is able to enjoy the benefits of having a cooking device with a lid, while also avoiding the potential of injury or damage associated with stowing a hot cooking device in the compartment of a recreational vehicle.

The fuel source box 22 preferably includes a chamber 48 and a cover 50. The source of fuel for the cooking device 16 can be placed in the chamber 48 and the cover 50 can be closed to ensure that the fuel source is protected. As a result, the fuel source box 22 can safely store the fuel source of the cooking device 16. Protection of the source of fuel helps preserve the integrity and quality of the fuel. Additionally, the protection of the source of fuel mitigates the chances that the fuel is accidentally exposed to a heat source.

The fuel source box 22 also preferably includes a horizontal extension 52. Inside the horizontal extension 52 is a channel 54 that opens to the chamber 48 where the source of fuel for the cooking device is kept. The horizontal extension 52 of the fuel source box 22 is received by the cavity 30 of the body 18. Once the horizontal extension 52 has been received in the cavity 30, the source of fuel can be delivered from the chamber 48, through the channel 54, and to the body 18 of the cooking device. By delivering the fuel from the fuel source box 22, damage to the connection between the fuel source and the cooking device 16 is mitigated, increasing the life of the cooking device and ensuring that fuel is properly being delivered to the cooking device 16.

On one side of the fuel source box 22 there are preferably four quick-connect and disconnect receiving members (55 and 56 are shown in FIG. 2). When the horizontal extension 52 of the fuel source box 22 is received in the cavity 30 of the body 18, the fuel source box 22 and the body 18 are removably attached via the quick-connect and disconnect mechanisms.

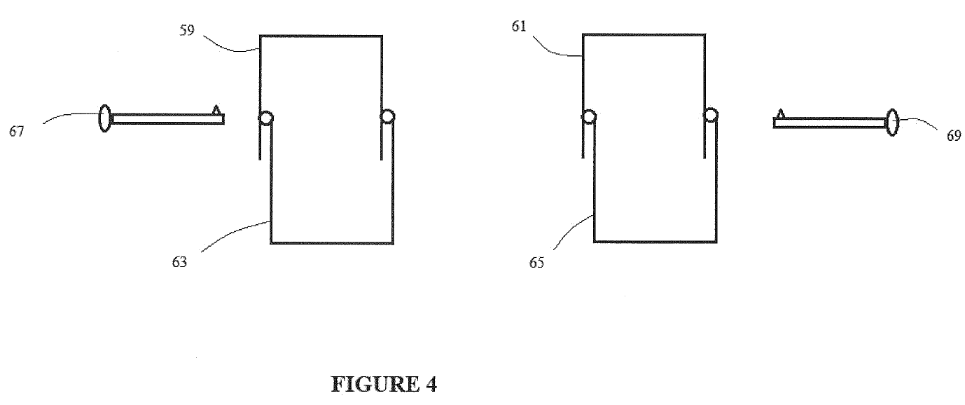

In FIG. 4, a version of the quick-connect and disconnect mechanism that removably attaches the fuel source box 22 to the body 18 is shown. The quick-connect and disconnect receiving members on the body 18 take the form of pin holes 59 and 61. The quick-connect and disconnect receiving members on the fuel source box 22 also take the form of pin holes 63 and 65. When the horizontal extension 52 of the fuel source box 22 is received in the cavity 30 of the body 18, the pin hole 59 of the body 18 aligns and overlaps with the pin hole 63 of the fuel source box 22, and the pin hole 61 of the body 18 aligns and overlaps with the pin hole 65 of the fuel source box 22. The fuel source box 22 is then removably attached to the body 18 by the insertion of a quick-connect and disconnect pins 67 and 69 70 along a horizontal plane through the overlapped in pin holes of the body 18 and the fuel source box 22.

The fuel source box 22 may have a height H4 greater or less than the height H1 of the compartment 14. If the height is greater, the fuel source box 22 must be disconnected and removed prior to stowing the body 18 in the compartment 16. When the fuel source box 22 must be removed before storage, it ensures that the source of fuel is safely stored away from the cooking device 16 to prevent the injury or damage associated with stowing a hot cooking device in a compartment with a fuel source.

The requirement that the cooking device needs to be disassembled prior to storage is counterintuitive, and a unique and inventive approach to solving the problem of storage of cooking devices in a safe manner. The use of quick-connect mechanisms for the lid and fuel source box is also counterintuitive in that use of such mechanisms may be seen as detrimental to the functionality (for example, heat retention between the body and the fuel source box) and stability of the device. However, any perceived disadvantages are outweighed by the safety gains of the present invention.

Many recreational vehicles come equipped with an outdoor kitchen type assembly on slide rails. These outdoor kitchens typically include stovetop surfaces with one or more burners and in some cases a griddle surface. The cooking assembly of the present invention is intended to replace the traditional, included stovetop portion of the outdoor kitchen, and allows the user to expand the cooking capabilities associated with the outdoor kitchen.

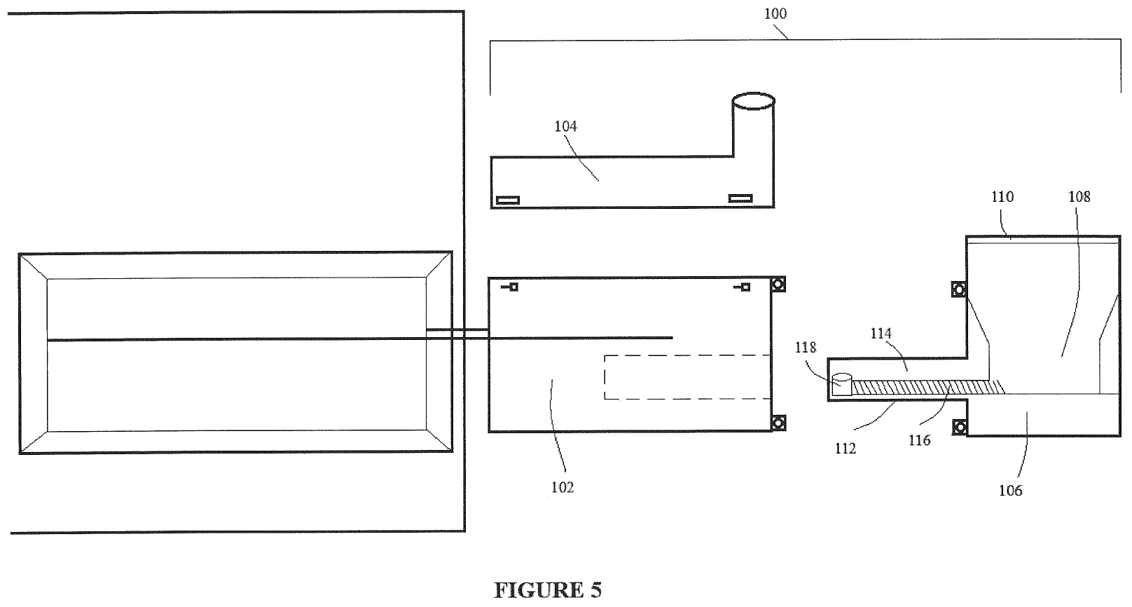

The cooking assembly of the present invention can take a number of forms. Preferably, the device takes the form of a pellet-style grill (as described below in FIG. 5), wherein the fuel source box contains fuel pellets and has the necessary components to heat the pellets.

Within the concept of the present invention, the cooking assembly could also take the form of an offset smoker, wherein the fuel source box serves as the fire box for the smoker. In this case, since the fuel source box is easily removed, once partial cooling occurs, the fuel source box can be carefully removed and spent/hot fuel discarded, so that the fuel source box can cool more quickly and at the same rate of cooling as the body.

In FIG. 5, an embodiment of the present invention is shown, wherein the cooking device is a pellet smoker 100 having a body 102, a lid 104, and a pellet box 106. In this embodiment the pellet box 106 includes a chamber 108 and a cover 110 so as to allow the user of the pellet smoker 100 to safely store pellets in the pellet box 106. The pellet box 106 also includes a horizontal extension 112 having a channel 114 that contains an auger gear 116 and a pan 118. The channel 114 containing the auger gear 116 meets the chamber 108 where the pellets are kept. The auger gear 116 then provides pellets from the chamber 108, through the channel 114, and into the pan 118. The pan 118 can be the location of a heating element.

As noted above, the cooking device may take the form of other types of grills and smokers, such as an offset smoker, wherein the fuel source box serves as a fire box, which must be removed prior to storage. The cooking device could also take the form of a more conventional grill (gas or charcoal), so long as the height of the body and lid together is greater than the height of the opening of the compartment.

The foregoing disclosure and description of the invention is illustrative and explanatory thereof. Various changes in the details of the illustrated construction can be made is the scope of the present invention without departing from the true spirit of the invention. The present invention should only be limited by the following claims and their legal equivalents.

1. A recreational vehicle cooking assembly comprising:
a recreational vehicle compartment having an opening with a height;
a cooking device slidably received in the recreational vehicle compartment, the cooking device having a body with a height, wherein the height of the body is less than the height of the opening of the recreational vehicle compartment; and
a cooking device lid removably attached to the cooking device body, the cooking device lid and body having a combined height greater than the height of the opening of the recreational vehicle compartment.

2. The recreational vehicle cooking assembly of claim 1, further comprising:
a fuel source box removably attached to the cooking device body, the fuel source box having a height greater than the height of the opening of the recreational vehicle compartment.

3. The recreational vehicle cooking assembly of claim 2, wherein the cooking device is a pellet grill, wherein the fuel source box comprises:
a chamber for storage of fuel pellets;
a horizontal extension received in the cooking device body; and
an auger extending through the horizontal extension.

4. The recreational vehicle cooking assembly of claim 2, wherein the cooking device is an offset smoker, wherein the fuel source box is a fire box.

5. The recreational vehicle cooking assembly of claim 1, wherein the cooking device lid is removably attached to the cooking device body with a quick-connect mechanism.

6. The recreational vehicle cooking assembly of claim 5, wherein the quick-connect mechanism comprises a male portion slidably received in a female portion.

7. The recreational vehicle cooking assembly of claim 5, wherein the quick-connect mechanism comprises a pin received through aligned passageways formed on both the cooking device lid and the cooking device body.

8. The recreational vehicle cooking assembly of claim 2, wherein the fuel source box is removably attached to the cooking device body with a quick-connect mechanism.

9. The recreational vehicle cooking assembly of claim 8, wherein the quick-connect mechanism comprises a key hole and a corresponding bolt head sized to fit within the key hole.

10. A cooking device comprising:
a cooking device body;
a cooking device lid removably attached to the cooking device body with a first quick connect mechanism; and
a fuel source box removably attached to the cooking device body with a second quick connect mechanism.

11. The cooking device of claim 10, wherein the first and second quick connect mechanisms each comprise a male portion slidably received in a female portion.

12. The cooking device of claim 11, wherein the male portion and female portion collectively form a hinge and wherein the male portion slides horizontally so as be received by the female portion.

13. The cooking device of claim 11, wherein the male portion comprises a pin, and wherein the female portion comprises a set of aligned passageways.

14. The cooking device of claim 11, wherein the male portion comprises a bolt having a bolt head, and wherein the female portion comprises a key hole slot, the bolt head being received in the key hole slot.

15. The cooking device of claim 10, the fuel source box comprising:
a chamber for storage of fuel pellets;
a horizontal extension received in the cooking device body; and
an auger extending through the horizontal extension.

16. A recreational vehicle cooking assembly comprising:
a recreational vehicle compartment having an opening with a height; and
a cooking device slidably received in the recreational vehicle compartment, the cooking device comprising:
a body with a height, wherein the height of the body is less than the height of the opening of the recreational vehicle compartment;
a lid removably attached to the cooking device body with a first quick-connect mechanism, the lid and body having a combined height greater than the height of the opening of the recreational vehicle compartment; and
a fuel source box removably attached to the cooking device body with a second quick connect mechanism.

17. The recreational vehicle cooking assembly of claim 16, wherein the cooking device comprises a pellet grill, the fuel source box adapted to store fuel pellets.

18. The recreational vehicle cooking assembly of claim 17, the fuel source box comprising:
a chamber for storage of the fuel pellets;
a horizontal extension received in the cooking device body; and
an auger extending through the horizontal extension.

19. The recreational vehicle cooking assembly of claim 16, wherein the first and second quick connect mechanisms each comprise a male portion slidably received in a female portion.

20. The cooking device of claim 11, wherein the male portion and female portion of the first quick connect mechanism collectively form a hinge and wherein the male portion slides horizontally so as be received by the female portion.
